(19) United States
(12) Patent Application Publication
(10) Pub. No.: US 2011/0121956 A1
(43) Pub. Date: May 26, 2011

(54) Security system for preserving life left inside hot vehicle

(76) Inventor: David Falcon Rodriguez, Orlando, FL (US)

(21) Appl. No.: 12/592,389

(22) Filed: Nov. 24, 2009

(51) Int. Cl. B60Q 1/00

(52) U.S. Cl. 340/425.5; 340/584

(57) ABSTRACT

A security system which comprises temperature and movement sensors, and two timers. One of them for controlling a relay and the second timer. The relay, upon activation, triggers the theft alarm system. The second timer switches activate the power window motors to open the windows and to make a phone call. All this allows outside air to cool down the vehicle cabin, provides easy access/exit, alert nearby people for help, and also sends a remote alert to the person called. So, the present invention accomplishes its primary function of preserving life left in hot vehicles by taking measures to directly prevent life loss inside hot vehicles and alert nearby and remote people for assistance.

### BACKGROUND OF THE INVENTION

1. Field of the Invention

The present invention relates to the field of providing effective safety measures to prevent life threatening situations because of human or animal presence left inside hot vehicles.

2. Description of the Related Art

The available vehicle security systems help fighting delinquent activity, alert of damage caused to the property in case of accident. Others security systems close the windows before a roll over accident is detected is going to happen, and open them after it to facilitate victims getting out of the vehicle or easier assistance to them. There is a system that secures the doors after the vehicle starts moving to avoid children from opening the doors with the vehicle moving.

Every year, news related to children or pets left inside hot cars strike us, with families suffering the consequences of neglect, or intentional behavior leading to human or animal loss.

Today, to my knowledge, there is not a related art intended to offer a way to avoid death inside hot vehicles; which is somewhat disconcerting.

Reading newspapers reflecting these cases moved me to think that there should be a way to help preventing more life loss because of the aforementioned cause. This is the goal I pursued in the present invention.

### SUMMARY OF THE INVENTION

The present invention provides a security system for extended use in the auto industry in general. Because of the cabin temperature and movement sensors provide continuous monitoring of life presence and its eventual deterioration in case of prolonged exposure inside a hot vehicle cabin, this security system takes active measures to ensure:

Outside cooler air exchange with hot air trapped inside the vehicle cabin, by activating all windows opening mechanisms when high temperature and life presence is detected.

People nearby is alerted by activating the vehicle theft alarm systems, thus providing immediate help and easy access to those in need.

A phone call is made to alert of the endangered life left in a hot vehicle cabin, by using a cell phone connected to the security system.

The temperature and movement sensors are conveniently placed inside the cabin to ensure the effective operation. Also, several movement sensors can be used, but one placed on the center of the interior part of the roof panel in the cabin is recommended as it monitors the front and rear seats on two row seats vehicles. In large vans, buses, RVs, etc; more than one movement sensor may be needed. The sensitivity and timing of said movement sensor is adjusted to perform accordingly, as well as the timers it controls.

### BRIEF DESCRIPTION OF THE DRAWINGS

In the present invention, features of the claimed subject matter will become apparent as the following detailed description proceeds, and upon reference to the drawings, where numerals and letters depict like parts, and in which:

FIG. 1 is a circuit diagram showing the present embodiment when the security system is in monitoring mode.

FIG. 2 is a copy of the FIG. 1 circuit diagram showing the present embodiment when inside the vehicle cabin the temperature exceeds certain preset limit, life presence is detected, and the security system is in operation mode.

FIG. 3 is a block diagram showing a vehicle theft alarm system in which has being added the relay switch 18.1 intended for activation of said theft alarm system.

FIG. 4 is a schematic diagram of a cell phone with the internal call key contacts exposed to show its connection to one of the second timer switches 19.9.

### DETAILED DESCRIPTION OF THE INVENTION

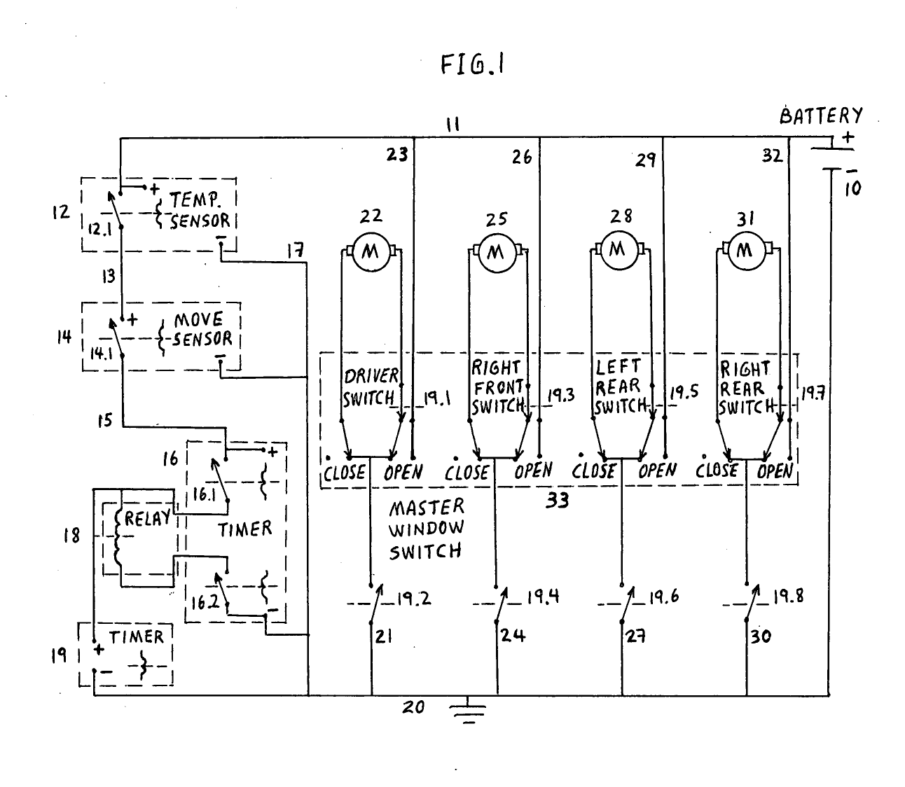

The present invention illustrates the monitoring mode of an electronic device FIG. 1, having a 12V DC vehicle battery 10, a temperature sensor 12, a movement sensor 14, a timer 16 with a relay 18 and a second timer 19 connected to it. The master window switch 33 (located in the driver door panel) is shown with the driver switch, the right front, left rear and right rear window switches of said master window switch 33; which should be connected to the present embodiment as it is shown. The power window motor of the driver, front passenger (right front), left rear, and right rear windows 22, 25, 28, 31 respectively are also shown. They have the second timer switches 19.1, 19.3, 19.5, 19.7 connected to the open side of the respective window switches. In this FIG. 1 it is shown the primary monitoring mode in which:

The battery 10 positive terminal connects to a temperature sensor 12 through wire 11; to the open position of the master window switches through wires 23, 26, 29, 32. The temperature sensor is an electronic device with a normally open switch (NO) 12.1, which is connected to a movement sensor 14 positive terminal and its NO switch 14.1. The wire 15 connects 14 to the timer 16 positive terminal and to one of its switches 16.1. The relay 18 is connected to the timer 16 through the switches 16.1/16.2. A second timer 19 is connected to the timer switch 16.1 and to ground through wire 20. The temperature sensor 12, movement sensor 14, and timer 16 are connected to ground through wire 17.

The temperature sensor 12 and the movement sensor 14 are monitoring the vehicle cabin. The sensor 12 is preset to a certain temperature after which the physiological conditions of a life organism start deteriorating. The movement sensor 14, Timer 16, the relay 18 and second timer 19 connected to it, as well as the master window switch 33 and power window motors 22, 25, 28, 31 are not connected to the battery 10 positive terminal, because the temperature sensor 12 has not detected temperature over the preset limit and 14 has not detected life presence inside the cabin.

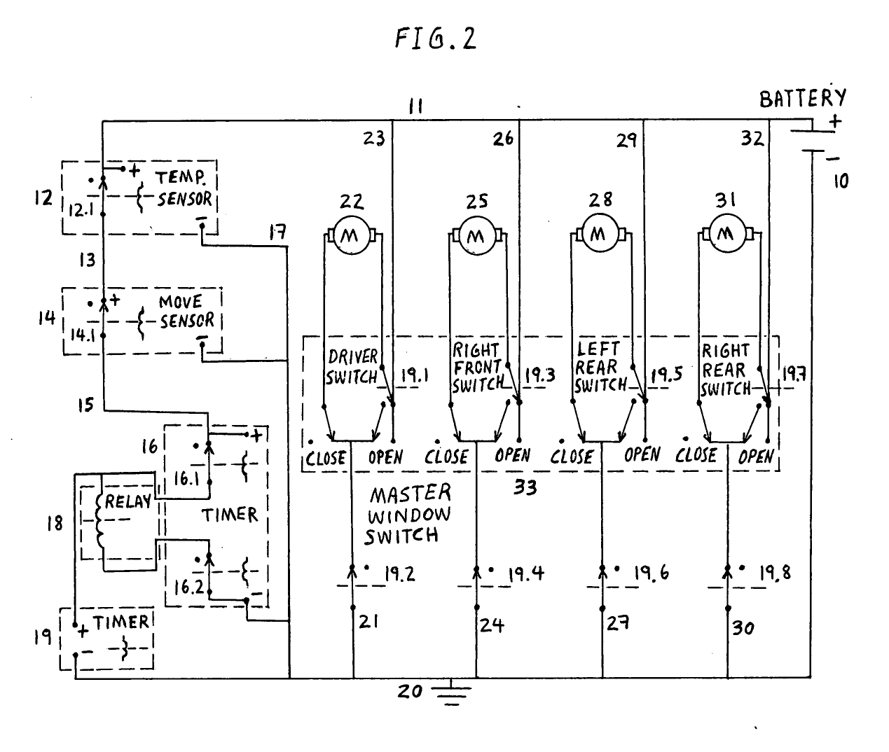

FIG. 2 illustrates the system in operation mode, in which the temperature inside the vehicle cabin reaches the preset limit, activating the switch 12.1. Battery DC power is supplied through wire 13 to the movement sensor 14 which activates 14.1 upon life presence is detected. The timer 16 is then connected to DC battery power trough wire 15. After a preset time, the switches 16.1/16.2 activate to deliver DC power to the relay 18 (activating its switch 18.1) and the second timer 19. The timer 19 which switches 19.1, 19.2, 19.3, 19.4, 19.5, 19.6, 19.7, 19.8 connected to the master window switch 33, are activated for less than a minute to connect the respective window motors (22, 25, 28, 31) to DC positive power through wires 23, 26, 29, 32. The driver switch, right front switch, left rear switch, and right rear switches have connected 19.1, 19.3, 19.5, 19.7 to the open position side of them. The switch 19.9 is connected to a cell phone call key FIG. 4, which is activated to close the cell phone call key contacts; thus a phone call is made to the preset (highlighted) number on the display. The person who receives the call is alerted.

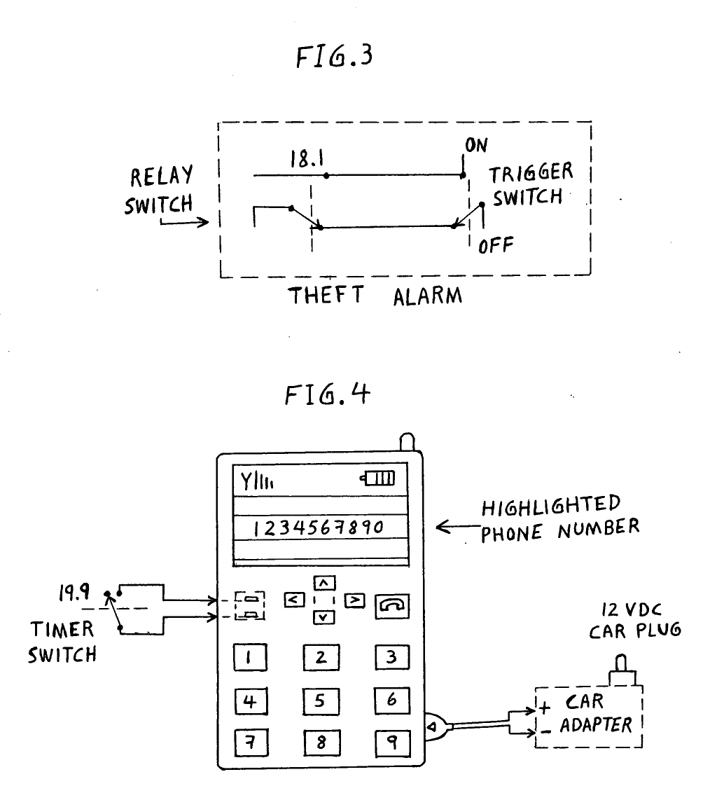

Switches 19.2, 19.4, 19.6, and 19.8 close to connect one wire of the window motors 22, 25, 28, 31 to ground. The power window motor 22, 25, 28, 31 are connected to positive DC power through the wires 23, 26, 29, 32, which are bridged by switches 19.1, 19.3, 19.5, 19.7. The vehicle windows open, allowing the outside air exchange with the hot air in the vehicle cabin and thus cooling it. The relay 18 FIG. 3, have its switch 18.1 connected to the OFF position of a trigger switch of the theft alarm system. When the switch 18.1 is activated, the theft alarm system is then also activated and starts blinking the vehicle lights and sounding the horn. People nearby is alerted.

There are two parameters the security system monitors (temperature and movement), that are subject to change independently, once the windows are opened and the alert is sent to nearby people, and the one called:

When temperature inside the cabin decreases due to the air exchange cooling effect, the temperature sensor 12-FIG. 1 opens its switch 12.1 and so the bridge between wires 11 and 13, so that battery power 10 to wire 13 is interrupted, the movement sensor 14, timer 16, relay 18 and second timer 19 are deactivated.

When movement is no longer detected inside the vehicle cabin, the movement sensor 14-FIG. 1 opens its switch 14.1 and wire 13 to 15 are disconnected, interrupting the DC voltage applied to the timer 16, the relay 18 and the second timer 19. The temperature, if still high, keeps wires 11-13 connected, but the circuit line formed by 13 to 15 and 16 is opened by 14.1.

The timer 16 (set to 2-3 minutes delay) makes sure that any detected movement by 14, is prolonged and not for just a few seconds, like might be passing vehicles that move the pavement, someone that hits the vehicle while parking, etc. Continuous/uninterrupted movement for 2-3 minutes means life presence in the vehicle cabin.

The timer 19 should be set with a delay time of less than a minute (time counting starts after the timer 16 activated its contacts 16.1/16.2 when the movement sensor 14 detects life inside the vehicle cabin and powers 16). When timer 16 closes the contacts 16.1/16.2, the DC battery power 10 activates the relay 18 and the secondary timer 19. This secondary timer 19 is set with a delay time enough for the door power window motors 22, 25, 28, 31 to fully open the windows when the contacts 19.1, 19.2, 19.3, 19.4, 19.5, 19.6, 19.7, and 19.8 close (less than half a minute). The phone call is made by the cell phone FIG. 4 just after the contacts 19.9 close. The relay 18, upon activation by the contacts 16.1/16.2 of timer 16, activates its switch 18.1 connected to a trigger switch, thus triggering the theft alarm system on FIG. 3 to which it is connected.

Once the phone call is made, the person who receives it, reads on the display of his/her phone, the number/message assigned to identify the cell phone inside the vehicle cabin (Could be . . . run to your car, left in hot car, life endangered, etc). As the person called hangs on, the cell phone in the vehicle keeps highlighting the previously selected phone number in the display (the one just called). A car charger keeps the phone on, FIG. 3.

On the market there is a system called Onstar, which after a robbery or accident has occurred to a vehicle, a phone call is made to a service provider to which a monthly fee must be paid. In the described invention I foresee using a prepaid cell phone, which minutes of call are paid when used. As this cell phone placed inside the vehicle might never make a call, it is convenient to pay, let's say . . . five dollars once to have it ready; just to allow the emergency call takes place when necessary. On this cell phone the settings must prevent any incoming call by rejecting it.

As can be seen, the present invention may have different arrangements of the various component depicted and their connection to the circuit, as well as components not shown, excluded or exchanged. All of that is possible without departing from the spirit and scope of the present invention. The components used, as well as the designed circuit; were purposely chosen to comply with the primary rule of simplicity and lowest possible cost. Thus, it can be broadly used by the auto industry in general, as well as in any other application where the present invention may be adapted just by adding, excluding, or exchanging some components, or slight variations to the circuitry. Also the components can be selected appropriately to function with a different voltage supply.

The terms and expressions employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1. A security system for its use in a vehicle cabin to provide constant active monitoring of vehicle cabin temperature and life presence. Said system comprising a temperature sensor adjustable to a set temperature, at which it supplies the DC power from the battery to activate a movement sensor. A movement sensor, for monitoring life presence inside a vehicle cabin, that after movement is detected, activates a timer. Said timer, for setting a delay time (this makes sure movement source is prolonged-like happens with human/animal beings) after which provides battery DC power to a relay and a second timer. A relay, which when actuated, triggers the theft alarm system. And a secondary timer with a delay time, during which its switches are activated, delivers DC battery power to the power window motors to open the windows. This timer, also close its contacts connected to the phone circuitry, in parallel to the internal contacts of the call key of a cell phone, which has a preset phone number highlighted to be called upon closing said call key contacts.

2. The system of claim 1 comprising a temperature and movement sensor, two timers, and a relay; all of which are not of a specific kind and can be exchanged for other components and similar circuitry, given the fact they function accordingly to activate the security system for preserving life as described in this invention.

3. The system of claim 1 making use of widespread theft alarm systems installed in today vehicles for the purpose of alerting nearby people; as well as the use of electric power windows systems installed in current vehicles, for the purpose of refreshing the air inside the cabin, providing exit to victims, or easy access to those coming to help the ones left in hot vehicle cabins.
